(19) United States
(12) Patent Application Publication
(10) Pub. No.: US 2002/0151826 A1
(43) Pub. Date: Oct. 17, 2002

(54) MASSAGE APPARATUS AND METHODS

(76) Inventors: JOHN S. RAMEY, OREM, UT (US); LARRY K. BEARDALL, SANDY, UT (US)

Correspondence Address: KIRTON AND MCCONKIE, 1800 EAGLE GATE TOWER, 60 EAST SOUTH TEMPLE, P O BOX 45120, SALT LAKE CITY, UT, 84145-0120, US

(21) Appl. No.: 09/309,958

(22) Filed: May 11, 1999

(51) Int. Cl. A61H 7/00

(52) U.S. Cl. 601/6; 601/9

(57) ABSTRACT

A massage device comprising a head which defines a cavity and an opening to the cavity. The head has one or more contact surfaces and a post connected to the head. The post is positioned within the cavity and extends toward the opening. The post also has one or more contact surfaces. A vacuum source communicating with the cavity provides a means for creating negative pressure within the cavity.

### BACKGROUND

1. The Field of the Invention

This invention relates to massage devices and methods and, more particularly, to novel apparatus and methods for use in providing aesthetic massages.

2. The Background Art

In the health and beauty industry there has been a great deal of interest in the use of massage and body contouring treatments for their therapeutic and cosmetic value. Massage and body contouring can provide such benefits as the increase of local blood circulation, and relief of minor muscle aches and pains. It has also been reported that such treatments may aid in reducing the appearance of cellulite, smoothing the skin and reducing girth. Moreover, patients find massage and body contouring treatments to be relaxing.

Traditionally massages are given by hand, usually by a masseuse who has received extensive training in various hand massage techniques. One technique known as petrissage is described as kneading or lifting and rolling of the skin. For example, to perform the petrissage technique, the skin and surface muscles of the person receiving the massage can be gently grasped between the thumb and fingers with a pinching-like motion. Petrissage is reported as being stimulating to muscles and to circulation of the deeper blood vessels and lymphatics. Another hand massage technique called effleurage is described as a long, gliding or stroking movement on the surface of the skin, often using the entire, flat surface of the hand to stroke the skin. Effleurage is a soothing technique and is reported as increasing circulation and relaxation in patients. Other massage techniques include friction, tapotement, and vibration.

Massage treatments given by hand can be costly for the patient and tiring for the masseuse. In addition, manual manipulations are not typically capable of sustained massage of deep subdermal tissue layers. In an attempt to reduce the expense and effort required for hand massage, various mechanical massage and body contouring devices have been developed. These massage and body contouring devices imitate, to some degree, the manipulation of the skin, the direction or pattern of that manipulation and the pressure applied to the skin associated with various hand massage techniques. Thus, the aim of many massage and body contouring devices is to provide a patient with the same or similar type of massage as can be received by hand while reducing cost to the person receiving the treatment and reducing the training and effort required of the person giving the treatment.

Prior art massage and body contouring devices employ various means for simulating massage techniques. For example, prior art devices attempt to simulate the kneading or lifting and rolling of the skin experienced when a petrissage technique is used. Some of these prior art devices use a vacuum means for lifting the skin. Other prior art devices use various types of rollers to lift and knead the skin. The rollers are generally cylindrical in shape and may also be combined with other mechanical or vacuum means for lifting the skin. Other devices employ motorized or mechanically activated rollers which squeeze skin between the rollers.

U.S. Pat. No. 4,729,368 to Guitay discloses an apparatus for massaging the human body comprising in part “two parallel active rollers, preferably driven in rotation by a motor,” the rollers are “mounted inside a manually operated housing.”

U.S. Pat. No. 3,841,323 to Stoughton discloses a “massage apparatus by which pulsating air suction is applied to any selected area of the human body so as to stimulate circulation of the blood . . . The apparatus includes a bellows which is coupled to a suction cup through an elongated flexible tube.”

U.S. Pat. No. 3,841,322 to Spelio discloses “a variable pulsating vacuum device to transmit rhythmic suction-relaxation manipulative action through tubing to applicators in contact with the facial and neck tissue.”

In PCT international application No. PCT/FR95/00890, Guitay discloses a “massaging apparatus intending to perform massage treatments through an action of suction and mobilization of the skin tissue. It is comprised of parallel rollers . . . mounted inside a casing . . . and between which is created a depression when the apparatus is applied against the patient's body.”

In U.S. Pat. No. 5,665,053, Jacobs discloses “an endermology body massager having at least two rollers spaced from each other in a parallel configuration. The rollers rotate in the same direction and are rotatably mounted movable axes. A vacuum source is connected to the chamber that houses the rollers.”

U.S. Pat. No. 5,215,078 to Fulop discloses “a massager [which] includes an electric motor driven eccentric cam . . . in a housing . . . . A moving member . . . is slideably mounted on the housing and is driven by the eccentric cam in a reciprocating, translatory motion relative to the housing.”

Using a roller as a lifting or petrissage element in a body contouring or massage device as disclosed in some of the prior art above can be disadvantageous in that use of rollers increases the manufacturing cost of the device and complicates assembly of the device. Cost and complexity of manufacturing are especially increased for devices employing rollers which are motorized or otherwise mechanically activated. Similarly, maintenance and repair of devices with rollers can increase the overall cost to the purchaser. Devices with moving parts may require regular replacement of the moving parts which malfunction or wear out. Moreover, motorized and mechanized roller devices can be difficult to clean and may require partial disassembly to clean. Some rollers also limit the direction and movement of the device along the skin of the patient, restricting movement of the device to substantially forward and backward movements. In this way, roller devices limit the types of treatments that can be offered using the device and may prove difficult to use.

It has been found that there is discomfort related to prior art designs of massage and body contouring devices. For example, in devices using rollers, the patient's skin may be pinched. As the roller moves along the surface of the skin, the skin can be drawn up along the roller and get caught in the space between the roller and the housing of the device. Where the lifting action of the skin is increased by motorized or mechanically activated rollers or by a vacuum source, the patient's discomfort from pinching may increase. The design of the housing of the device may increase a patient's chances of uncomfortable contact with sharp edges or comers of the housing, such as with a square or angular shaped device. In devices using vacuum suction to lift the skin, if the portion of the device which contacts the patient's skin to create the vacuum seal has sharp edges, the vacuum suction may cause the skin to be pinched along the area of the seal. This is particularly the case when the vacuum suction becomes too strong, and there is no safety release valve to reduce the suction. A patient's skin may also be irritated by the device where the device comes into direct contact with the skin.

### BRIEF SUMMARY AND OBJECTS OF THE INVENTION

It is reported that the size of fat cells in superficial adipose layers can be affected through external massage. Specifically it is reported that vasodilation in combination with physical force upon a fat cell can remove volume from the fat cell into lymphatic and venous channels, creating a chance to eliminate this volume from the body through the kidneys or to burn it by exercise. The present invention may provide a mechanical means for creating an environment into which the volume of fat cells and superficial adipose layers may be reduced using positive and negative pressure on the skin above the superficial adipose layer.

The present invention provides a means for applying positive and negative pressure on the skin. More specifically, the present invention provides a means for applying positive pressure on an area of skin undergoing negative pressure. As used herein, the term “skin” refers primarily to the epidermis and derma but may include other deeper dermal and non-dermal tissues and associated structures. The device also includes a kneading or petrissage element and a stroking or effleurage element.

Generally, the device comprises a head, a post and a handle. The head being substantially spherical or semi-spherical and defining a broad, substantially flat rim and a concave cavity with an opening.

Extending from the wall of the concave cavity toward the opening is a post. The post is connected to the head but a portion of the post is free. The free portion of the post extends toward the rim and may be slightly recessed within the cavity. The free portion provides a skin contact surface. The post may be substantially cylindrical, the cylindrical post being connected to the head at one end of the cylinder and having a skin contact surface on the other end. The contact surface can be substantially flat and/or fixed, a fixed contact surface being one that does not move relative to the post or head. The rim, as defined by the head, also has a contact surface which can be substantially flat and/or fixed. The head defines an orifice leading from the cavity to the vacuum source.

The handle is connected to the head at one end of the handle. The handle defines an internal conduit running lengthwise inside the handle, the conduit having two open ends. On one open end of the conduit, the conduit opens into the orifice defined by the head; the second open end of the conduit is connected to the vacuum source.

The head includes an outer or peripheral effleurage element and the post includes an inner or central effleurage element, the outer element being externally and radially outward from the internal effleurage element.

The vacuum source has a bleed-off valve in order to avoid subjecting a patient to excessive vacuum pressure. A barrier between the skin and the device is used to reduce or prevent possible irritation from contact of the device with a patient's skin and to allow the device to move more freely along the skin.

It is, therefore, an object of the present invention to provide a device and method for massage and body contouring which is simple to manufacture. The cost of the device and ultimately the cost of the treatment for the patient or customer can be significantly reduced if the device can be manufactured as a single piece or only a few pieces, such as a device which can be milled or injection molded. It is also more simple to manufacture a device that does not have rollers or other moving parts.

It is another object of the present invention to provide a method and device which can be easily maintained. A massage or body contouring device with no moving parts is less likely to need repair or replacement parts and can be easily cleaned.

It is still another object of the present invention to provide a device which is easy to use, allowing for multi-directional movement and circular movement of the device when the device is being used, by not inhibiting or restricting movement of the device along the skin of the patient with rollers, corners or sharp edges.

It is an additional object of the present invention to provide a device which minimizes uncomfortable contact with the device by preventing the creation of painful or harmful negative pressure and by limiting the negative pressure which can be applied to the skin. It is therefore an object of the present invention to provide a massage device with a bleed-off valve. It is also an object of the present invention to reduce the potential for skin irritation or abrasion.

It is another additional object of the present invention to provide a device which provides a more comfortable seal between the skin and the device and which creates a soothing more relaxing massage treatment, and reduces the potential for pinching.

It is yet another object of the present invention to provide a device and method which provides for positive pressure on the skin, or in other words, compression of or increasing pressure around the skin, and to provide negative pressure on the skin, or in other words, a lifting of skin or reducing of pressure around the skin. More specifically it is an object of the present invention to provide positive pressure and negative pressure simultaneously and provide positive pressure to an area of skin which is undergoing negative pressure, which can more effectively disrupt fat cell membranes in the superficial adipose layer.

It is further an object of the present invention to provide a method for simultaneously applying a simulated stroking massage technique (effleurage) and simulated kneading (petrissage) massage and provide stroking or effleurage massage to an area of skin undergoing negative pressure to increase the comfort and effectiveness of the treatment.

### BRIEF DESCRIPTION OF THE DRAWINGS

The foregoing and other objects and features of the present invention will become more fully apparent from the following description and appended claims, taken in conjunction with the accompanying drawings. Understanding that these drawings depict only typical embodiments of the invention and are, therefore, not to be considered limiting of its scope, the invention will be described with additional specificity and detail through use of the accompanying drawings in which:

FIG. 1 shows a perspective view of one presently preferred embodiment of the present invention;

FIG. 2 shows the embodiment of FIG. 1 in longitudinal cross section;

FIG. 3 shows one embodiment of the present invention having a post capable of being releasably secured to the head;

FIG. 4 shows use of the present invention with a skin barrier;

FIGS. 5A and 5B illustrates various methods of using the present invention;

FIG. 6 illustrates positive pressure on an area of skin undergoing negative pressure and;

FIG. 7 shows a perspective view of the device attached to a vacuum source.

### DETAILED DESCRIPTION OF THE PREFERRED EMBODIMENTS

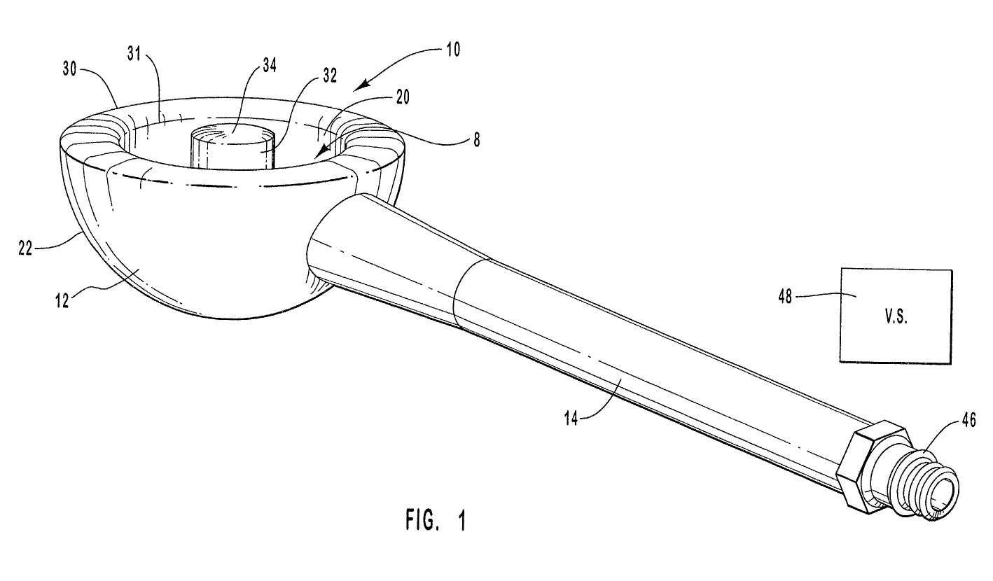

It will be readily understood that the components of the present invention, as generally described and illustrated in the Figures herein, could be arranged and designed in a wide variety of different configurations. Thus, the following more detailed description of the embodiments of the apparatus and methods of the present invention, as represented in FIGS. 1 through 7, is not intended to limit the scope of the invention, as claimed, but it is merely representative of the presently preferred embodiments of the invention.

The presently preferred embodiments of the invention will be best understood by reference to the drawings, wherein like parts are designated by like numerals throughout.

The present invention comprises a device and method for applying positive pressure to an area of skin undergoing negative pressure. Subjecting an area of skin to negative pressure allows blood and lymph vessels beneath the area of skin being treated to dilate. Positive pressure applied to a portion of the skin area undergoing negative pressure causes vessels to be constricted. In combination, the positive pressure applied to an area of skin undergoing negative pressure results in increasing the supply of oxygen and nutrients to the skin, increasing venous and lymphatic drainage, and potentially disrupting fat cell membranes.

The device 10, shown in FIG. 1, comprises a means for applying negative pressure to an area of skin and means for applying positive pressure to the area of skin undergoing negative pressure. As explained above, negative pressure is a lifting of the skin or a reducing of pressure above and around an area of skin. The raising or lifting of the skin may be effected by bringing the skin into contact with an adhesive surface or applying a force to the skin along a vector which raises the skin, or reducing the atmospheric pressure above the skin by creating a vacuum to atmosphere above the surface of the skin. Alternatively any means by which skin may be safely raised above its resting position can be used to create negative pressure.

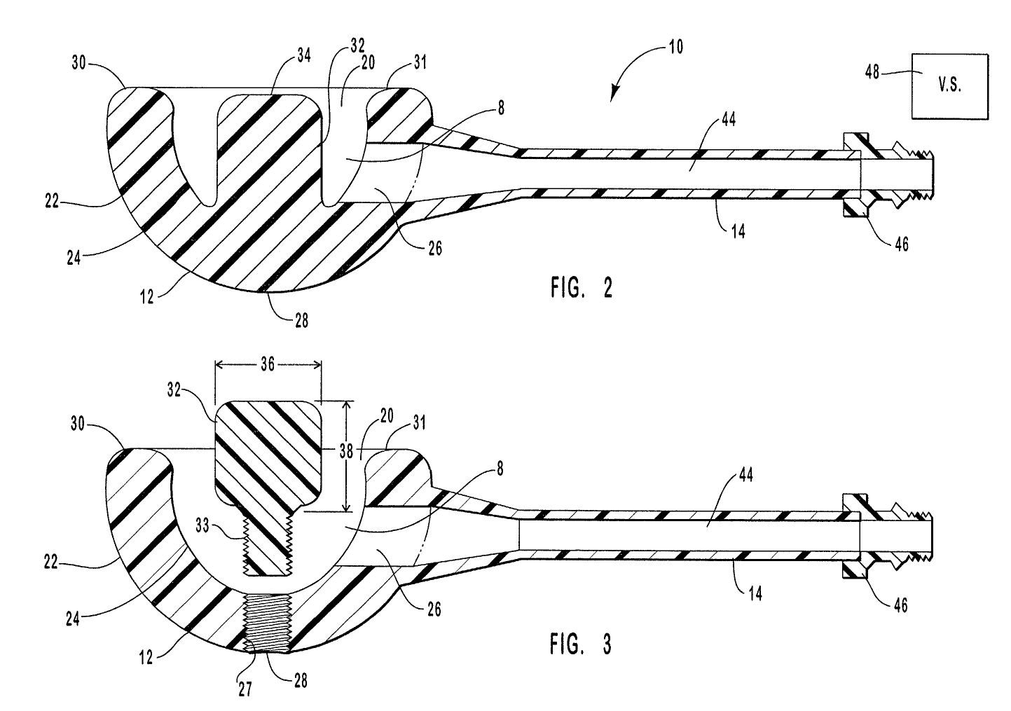

In the presently preferred embodiment, means for applying negative pressure to an area of skin is accomplished by creating negative pressure within cavity 8. Means for applying negative pressure to an area of skin comprises a head 12 defining a cavity 8. Head 12 is substantially semi-spherical, although it will be readily appreciated that other shapes may be used for head 12 consistent with the present invention. Cavity 8 is defined by a substantially concave inner wall 24 of head 12, as shown in FIG. 2. Head 12 has a substantially convex outer wall 22. Head 12 also defines a rim 30. Rim 30 defines a opening 20 which leads to cavity 8. At least one orifice 26 is defined by inner wall 24. Orifice 26 communicates with a vacuum source 48, such as by means of a hose 72 (see FIG. 7). Vacuum source 48 creates a vacuum to atmosphere within cavity 8.

Means for applying positive pressure is also provided by device 10. Positive pressure, briefly described above, is a compression of or increase in the pressure on an area of skin. Positive pressure may be affected by directing a force along a vector which physically compresses the skin. The positive pressure may be provided by physical contact between the device and the skin. Likewise, increasing air pressure around a portion or area of skin can provide positive pressure.

More specifically, means for applying positive pressure to an area of skin undergoing negative pressure comprises a post 32. As depicted in the Figures herein, post 32 is substantially cylindrical in shape and has a substantially flat contact surface 34. However, post 32 may also have other shapes consistent with the present invention. Post 32 has a diameter 36 and a length 38. The length 38 is such that post 32 is slightly recessed within the cavity 8 defined by head 12 and rim 30. Post 32 is connected to head 12 and extends away from concave inner wall 24, connecting to the head 12 at approximately the apex or center 28 of the concave inner wall 24, as shown in FIG. 2. It is contemplated that post 32 could be connected to concave wall 24 at points other than center 28. In a presently preferred embodiment, a single post 32 extends from concave wall 24, however a device having more than one post 32 is also contemplated. In a presently preferred embodiment, the post may be fixed but it is contemplated that the post may be movable such as up and down along its longitudinal axis or from side to side in pendulum fashion, when in use.

Handle 14 is connected to head 12 at one end and has an internal conduit 44 running longitudinally inside handle 14. The conduit inside handle 14 has a first open end and second open end. The first open end communicates with orifice 26. The second open end has means for attachment to a vacuum source 48. Handle 14 is preferably substantially cylindrical, having a length greater than its diameter and a circumference suitable for grasping by the user's hand. The surface of handle 14 may be grooved or otherwise have an ergonomic design. A vacuum source attachment means may be a vacuum hose adapter 46 or any suitable means of connecting conduit 44 to vacuum source 48.

Alternatively, handle 14 may be solid and orifice 26 may be connected to vacuum source 48 through a conduit 44 located outside handle 14. For example, conduit 44 may be a tube or conduit 44 communicating at a first open end of the tube with the vacuum source 48 and communicating at a second open end of the tube with orifice 26.

Using the device, an area of skin can be brought under negative pressure by bringing rim 30 into contact with the skin, sealing off opening 20 and creating a substantially air-tight seal between the skin and the rim 30. Rim 30 has a broad, substantially flat contact surface 31 allowing a broad seal with the skin. Negative pressure on the skin occurs as vacuum source 48 creates a pressure differential within the cavity 8. A substantially semi-spherical concave inner wall 24, assists in creating a generally uniform area of negative pressure. The absence of edges and corners along the concave inner wall 24 helps reduce uncomfortable contact between the skin and inner wall 24 and provides for a better seal with the skin. The broad, substantially flat contact surface 31 of rim 30 and the relatively long radii of curvature of the rounded edges along rim 30, as shown in FIGS. 1-4, prevent the negative pressure from lifting and pulling uncomfortably on the skin, and particularly the skin which by its contact with the rim, creates the seal at the perimeter of the area under pressure. An area of skin is lifted by the pressure differential in cavity 8 (negative pressure) when the skin and rim 30 of head 12 come into contact to form a substantially air tight seal.

Generally, the device 10 is designed to have few edges. Specifically, rim 30 is designed to be substantially circular with rounded edges on either side of the broad, substantially flat contact surface. Similarly, post 32 is designed to be substantially circular with rounded edges adjoining the broad, substantially flat contact surface. A relatively long radius of curvature used in rounding edges increases the comfort to both patient and user and prevents uncomfortable contact with the device.

The device is functional with a post 32 that is not recessed within cavity 8, however, it is preferable that the post be recessed within cavity 8 creating a better seal between rim 30 and the surface of the skin. The improved seal allows for use of the vacuum at lower vacuum levels while maintaining an appropriate level of negative pressure within cavity 8.

Post 32 and rim 30 provide a positive pressure to the skin. Positive pressure to the area of skin undergoing negative pressure is achieved by post 32. Post 32 resists the negative pressure or lifting of the skin and places positive pressure on a portion of the skin undergoing negative pressure. Post 32 contacts skin which is inside the perimeter of the area undergoing negative pressure. Thus, when the device is in use and rim 30 creates a seal with the skin and thereby defines an area under negative pressure, rim 30 applies positive pressure to the skin along the perimeter of the area under negative pressure and post 32 also applies positive pressure, the pressure from post 32 being radially interior to the perimeter of the area under pressure. Negative pressure within the cavity 8 provides a creasing or lifting of the skin.

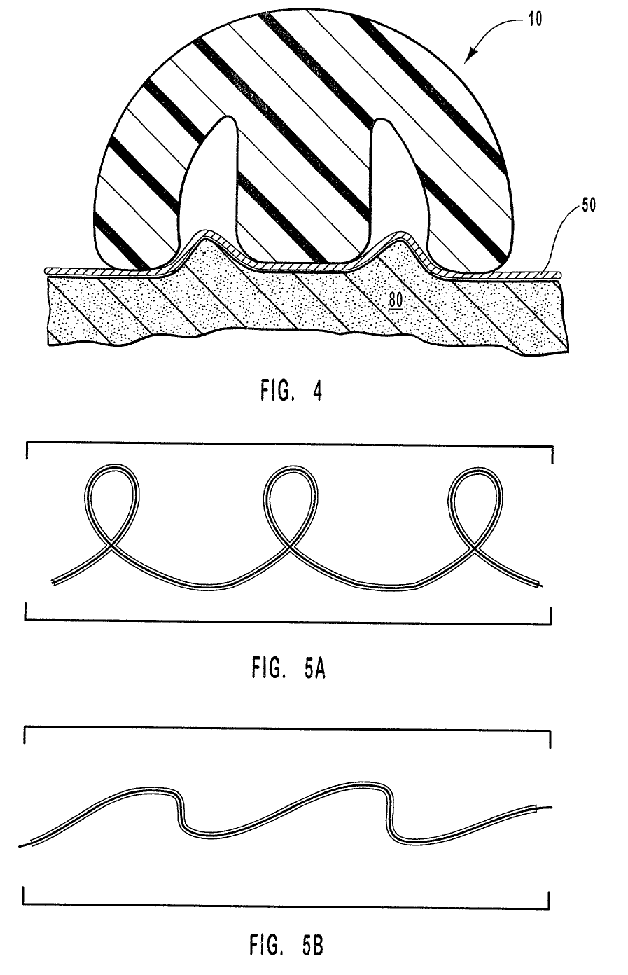

With negative and positive pressure applied to the skin, the device can be moved along the surface of the skin. The free movement of head 12 along the skin is greatly enhanced by its substantially semi-spherical shape and by post 32. Rim 30 is substantially circular, and post 32 is substantially cylindrical allowing the device to be easily moved in any direction along the surface of the skin, without having to break contact with the skin or re-orient the device. For example, post 32 facilitates movement of the device by limiting the height to which skin is lifted in cavity 8, thereby limiting the resistance to movement that could otherwise result from the lifted skin and allowing the device to move without the use of rollers. In other words, the device 10 is not limited to generally back and forth movements, as are cylindrical roller devices, and device 10 can be moved along the surface of the skin in any number of directions and patterns. As illustrated graphically in FIG. 5, device 10 can be comfortably moved in spiraling (FIG. 5A), wave (FIG. 5B), circular as well as other patterns along the skin.

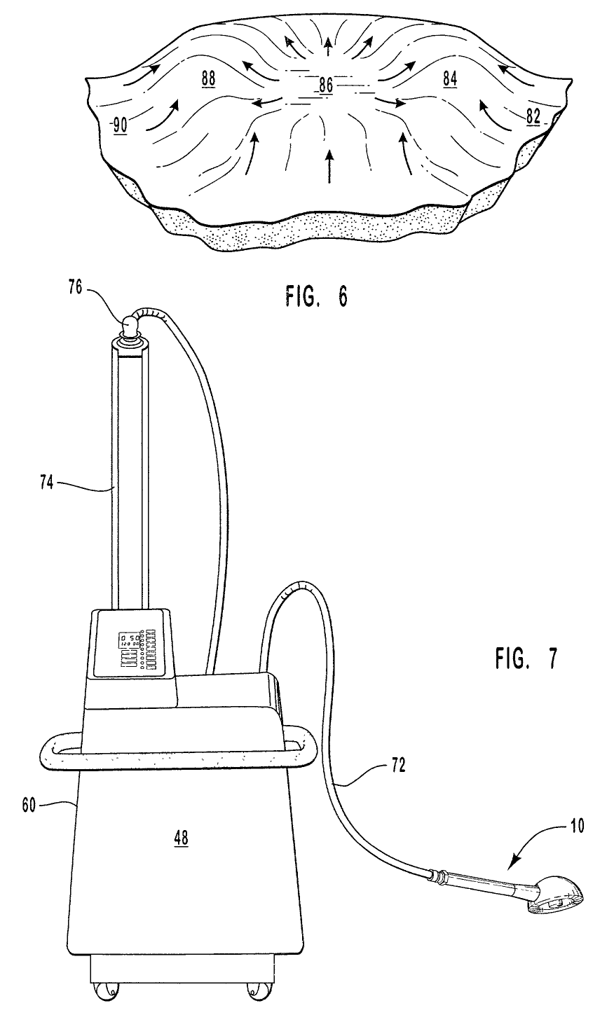

The positioning of post 32 radially interior to rim 30, with space between post 32 and rim 30 allows for an intermittent positive pressure and negative pressure effect on an area of skin as the head is moved along the surface of the skin. Referring to FIG. 6, as head 12 passes over a given area of skin, rim 30 provides initial positive pressure to the skin at 82. As the head is moved, the area of skin is next exposed to negative pressure within cavity 8, as shown at 84. As the head is moved still further, post 32 passes over a portion of the area of skin, as depicted at 86, producing positive pressure within the negative pressure area. The skin is then released from beneath the positive pressure of post 32 into the negative pressure or cavity 8 a second time, as illustrated at 88, and thereafter undergoes a final positive pressure from rim 30, as depicted at 90.

Rim 30 has a broad, substantially flat contact surface 3 1 which provides a stroking or effleurage-like massaging technique as the device passes over the skin, as does the substantially flat, contact surface 34 of post 32. Negative pressure created in cavity 8 lifts the skin. Both the inner wall 24 and the edge of rim 30 in combination with post 32 knead the lifted skin as the device is moved along the skin. This provides a petrissage-like massage technique as the device passes over the skin.

The radially interior positioning of post 32 relative to rim 30 also provides for intermittent effleurage-and-petrissage type massaging. The substantially flat contact surface 31 of rim 32 provides initial effleurage-like or stroking massage as it passes over an area of skin. The area of skin is then lifted as it is exposed to the negative pressure in cavity 8. Post 32 kneads the lifted area of skin. The substantially flat contact surface 34 of post 32 then passes over a portion of the area of the skin giving the stroking, effleurage-like massage. The skin is released from beneath post 32 into cavity 8, where the skin is lifted and kneaded by the edge of rim 30 and inner wall 24 of cavity 8. Finally, the substantially flat contact surface 31 of rim 32 then provides a stroking, effleurage-like massage.

The positive pressure provided by both post 32 and rim 30 in combination with the negative pressure created within cavity 8 creates a unique and effective area of positive and negative pressure along the portion of skin immediately surrounding and beneath post 32. As explained above, post 32 provides a positive pressure which resists the negative pressure or lifting of the skin created by the suction in cavity 8. The cylindrical shape of post 32 within the semi-spherical cavity 8 allows the negative pressure within the cavity to pull or lift the skin beneath post 32 in multiple directions. In other words, skin located beneath post 32 is pulled in opposite directions by the suction created on all sides of cylindrical post 32 as shown in FIG. 6. Arrows in FIG. 6 indicate the direction of the pull on the skin due to suction from the vacuum source. It is believed that this multi-directional pull on the skin beneath the post increases the potential for disruption of fat cells within the superficial adipose layer and further enhances the contrasting positive and negative pressure effect on the skin.

In the presently preferred embodiment, handle 14, head 12 and post 32 are a single unit, or in other words a single piece. The head piece is preferably manufactured of delron, though other plastics or materials could be used alternatively or in combination with delron. It is preferable that the device be made of a material that can be milled such as aluminum, brass, copper, steel, or other metals, or plastics, or similar materials or composites of such materials, so the device can be manufactured as a single unit, or in a single piece. Various sizes of the device can be constructed without changing the central features of the invention or complicating the invention by requiring redesign or miniature mechanization of elements of the invention. Milling also provides for a presently preferred finish.

In another embodiment, handle 14 and/or post 32 are releasably secured to head 12 as shown in FIG. 3, by means such as threads 27 and 33. A releasably securable post 32 allows the space between rim 30 and post 32 to be adjusted by using posts of different sizes to accommodate different levels of skin elasticity and increase patient comfort. Means for releasably securing the handle or means for releasably securing the post device include any securing means known in the art, for example, a threaded means, a slip-lock securing means, a pressure fitting means, hook and loop means, a fastener means or lashing means.

A barrier 50 shown in FIG. 4 can be placed on the skin 80 of the patient such that when the device is in use the barrier reduces or prevents possible irritation from direct contact between the skin 80 and the device 10. The barrier 50 can be solid or fluid. In a presently preferred embodiment, barrier 50 comprises a form fitting garment. Specific fluid or solid barriers 50, such as topical aminophylline gel, may enhance the therapeutic and/or cosmetic value of treatment with the device.

The use of heat in conjunction with the device is contemplated. The heat source can be external, such as heat packs and heat lamps, or the heat can be integral with the device. In the one embodiment the device 10 is heated prior to use.

A vacuum source 48 creates a negative pressure in cavity 8. Vacuum source 48 may be any suitable vacuum source known in the art. Preferred vacuum source 48 is capable of varying the vacuum at discrete negative levels, such as 10 discrete pressure levels between 2 inches and 15 inches mercury. Preferred vacuum source 48 is also capable of providing pulsating negative pressure levels, that is, increasing and decreasing pressure between two desired pressure levels, such as between any two negative pressure levels between 2 inches and 15 inches Hg. The pressure levels are selected according to patient comfort and desired treatment. In one embodiment, vacuum source 48 is an electric motor driven vacuum pump.

In one presently preferred embodiment, the vacuum source is a microprocessor controlled vacuum pump such as a Gast ¾ horsepower high volume vacuum pump. The voltage requirements of the vacuum source are 120 volts, 60 hertz, 13 amps or alternatively 240 volts, 50 hertz, 9 amps. The vacuum source 48 communicates with the device 10 through a hose 72. In one embodiment, the hose dimensions are 1.27 cm by 244 cm, but may have alternative dimensions suitable to the device 10 and the vacuum source 48. The Gast vacuum pump has a maximum suction lift of 27 feet. The vacuum pump is calibrated to preset levels. Alternatively, the vacuum pump can be piston, rotary vane, diaphragm, linear, or any other vacuum pump technology known in the art.

Vacuum source 48 may communicate with orifice 26 of device 10 by means of a tube 72 in combination with a boom 74 as shown in FIG. 7. Using a tube 72 in combination with a boom 74 helps to prevent unintended and potentially uncomfortable contact between the patient and the device and allows the user greater mobility.

A bleed-off valve 76 is connected to vacuum source 48 to limit the amount of negative pressure which can be brought upon the skin within cavity 8. The bleed-off valve 76 is disposed between handle 14 and vacuum source 48. In the presently preferred embodiment, the bleed-off valve opens at a pressure of about 17 to 18 inches of mercury. The bleed-off valve allows for the release of excess suction in the system, thereby preventing uncomfortable and potentially harmful pressure differences from occurring in the system. In a preferred embodiment, the bleed-off valve has an operating pressure range of 18 to 20 psi. Exhaust time is approximately 1 second. The valve is preferably composed of stainless steel, or similar metals. The valve is disposed between the vacuum source 48 and the device 10. In one preferred embodiment, the bleed-off valve is located within the housing 60 of a vacuum source 48. Bleed-off valves suitable for the purposes described are known in the art and readily available. Festo, Inc. is a manufacturer of the presently preferred bleed-off valve.

The present invention may be embodied in other specific forms without departing from its spirit or essential characteristics. The described embodiments are to be considered in all respects only as illustrative, and not restrictive. The scope of the invention is, therefore, indicated by the appended claims, rather than by the foregoing description. All changes which come within the meaning and range of equivalency of the claims are to be embraced within their scope.

What is claimed is:

1. A massage device comprising:
a head defining a cavity and defining an opening to the cavity, the head having a first contact surface;
a post connected to the head, the post positioned within the cavity and extending toward the opening, the post having a second contact surface;
a means for creating negative pressure within the cavity.

2. The device claimed in claim 1 wherein the first contact surface of the head is substantially flat.

3. The device claimed in claim 1 wherein the second contact surface of the post is substantially flat.

4. The device claimed in claim 1 wherein the first contact surface of the head is fixed.

5. The device claimed in claim 1 wherein the second contact surface of the post is fixed.

6. The device as claimed in claim 1 wherein the post is recessed within the cavity.

7. The device as claimed in claim 1 wherein the post is substantially cylindrical.

8. The device as claimed in claim 1 wherein the head further comprises a rim and wherein the post is interior to the rim.

9. The device as claimed in claim 1 wherein the head further comprises a rim and wherein the post is radially interior to the rim.

10. The device as claimed in claim 1 wherein the head further comprises a rim and wherein the rim has a substantially flat contact surface.

11. The device as claimed in claim 1 wherein the head further comprises a rim and wherein the rim has a fixed contact surface.

12. The device as claimed in claim 1 wherein the head further comprises a rim, the rim being capable of creating a substantially air tight seal.

13. The device as claimed in claim 1 wherein the cavity and means for providing negative pressure define a petrissage element and the first contact surface and second contact surface define an effleurage element.

14. The device as claimed in claim 1 further comprising means for releasably securing the post to the head.

15. The device claimed in claim 1 wherein the cavity is bordered by one or more inner walls.

16. The device claimed in claim 15 wherein the post is connected to the inner wall.

17. The device as claimed in claim 15 wherein the inner wall is concave.

18. The device as claimed in claim 1 wherein the means for creating negative pressure within the cavity is a vacuum source and wherein the head further comprises an orifice, the orifice communicating with the vacuum source.

19. The device as claimed in claim 18 wherein the vacuum source further comprises a bleed-off valve.

20. A device for massaging or body contouring comprising:
a head, the head having one or more inner walls and a rim, the head defining a cavity and an opening to the cavity, the opening being bordered by the rim, the rim being capable of creating a substantially air tight seal;
a post connected to the head and extending toward the opening; and
means for creating negative pressure within the cavity.

21. The device claimed in claim 20 further comprising one or more substantially flat contact surfaces.

22. The device as claimed in claim 21 wherein the post has a substantially flat contact surface.

23. The device as claimed in claim 22 wherein the head further comprises a rim and the rim has a substantially flat contact surface.

24. The device claimed in claim 20 further comprising one or more fixed contact surfaces.

25. The device as claimed in claim 24 wherein the post has a fixed contact surface during use.

26. The device as claimed in claim 25 wherein the rim has a fixed contact surface during use.

27. The device as claimed in claim 26 wherein the post is recessed within the cavity.

28. The device as claimed in claim 27 wherein the post is substantially cylindrical.

29. The device as claimed in claim 28 wherein the rim is substantially circular.

30. The device as claimed in claim 29 further comprising means for releasably securing the post to the head.

31. The device as claimed in claim 30 wherein the means for creating negative pressure within the cavity is a vacuum source and wherein the head further comprises an orifice, the orifice communicating with the vacuum source.

32. The device claimed in claim 31 wherein the post is connected to the inner wall of the head.

33. The device as claimed in claim 32 wherein the post is longitudinally adjustable during use.

34. A device for massaging or body contouring comprising:
a head having a concave inner wall and a rim, the concave wall defining an orifice communicating with a vacuum source and the rim having a substantially flat, contact surface, the concave wall and rim defining a cavity and an opening to the cavity, the cavity being substantially semi-spherical,
a post extending from the concave inner wall toward the opening, the post being slightly recessed within the cavity and having a substantially flat, contact surface, the post being substantially vertically cylindrical; and
a handle defining an internal conduit within the handle, the conduit having a first open end and a second open end, the conduit communicating with the orifice at the first open end and communicating with the vacuum source at the second open end.

35. A device for massaging an object comprising:
means for creating an area of negative pressure along a surface of the object, the area having a perimeter;
means for applying positive pressure to the area of skin undergoing negative pressure internal to the perimeter of the area; and
means for moving the area of negative pressure along the surface of the object while continuing to apply positive pressure.

36. The device as claimed in claim 35 wherein the means for creating an area of negative pressure is a head defining a cavity and a rim, a cavity communicating with a vacuum source and the rim being capable of creating a substantially air tight seal and wherein the means for applying positive pressure is a post.

37. A method for massaging an object comprising:
creating an area of negative pressure on the object, the area of negative pressure defined by a perimeter of positive pressure;
applying a second positive pressure radially interior to the perimeter;
moving the area of negative pressure defined by the positive pressure perimeter along the surface of the object while continuing to apply the second positive pressure in the area under negative pressure.
